(19) United States
(12) Patent Application Publication
(10) Pub. No.: US 2023/0323937 A1
(43) Pub. Date: Oct. 12, 2023

(54) GEAR WITH A THREE-PART STRUCTURE

(71) Applicant: ZF Friedrichshafen AG, Friedrichshafen (DE)

(72) Inventors: Marcel Pleyer, Melle (DE); Remt Blankenspeck, Barnstorf (DE); Thorsten Kamphaus, Lohne (DE)

(73) Assignee: ZF Friedrichshafen AG, Friedrichshafen (DE)

(21) Appl. No.: 18/295,080

(22) Filed: Apr. 3, 2023

(30) Foreign Application Priority Data
Apr. 7, 2022 (DE) 10 2022 203 534.8

(51) Int. Cl. F16H 55/17; F16H 55/06

(52) U.S. Cl. CPC F16H 55/17; F16H 2055/065; F16H 55/06

(57) ABSTRACT

The invention relates to a gearwheel (1, 11, 31) with a three-part structure consisting of an outer toothed rim (2), a connecting element (3), and a hub element (4). The outer toothed rim (2) has a plurality of teeth (5) and is made of a plastic material injection-molded onto an outer edge (16) of the connecting element (3). The connecting element (3) has a central through-going opening (7) and the hub element (4) is arranged in the said through-going opening (7). To enable a lighter and/or inexpensive structure, the gearwheel (1, 11, 31) is characterized in that the thickness of the connecting element (3) is less than that of the hub element (4), and the connecting element (3) has a plurality of reinforcing structures (17, 24).

### RELATED APPLICATIONS

This application claims the benefit of and right of priority under 35 U.S.C. § 119 to German Patent Application no. 10 2022 203 534.8, filed on 7 Apr. 2022, the contents of which are incorporated herein by reference in its entirety.

### FIELD OF THE DISCLOSURE

The invention relates to a gearwheel with a three-part structure consisting of an outer toothed rim, a connecting element and an inner hub element, wherein the outer toothed rim has a plurality of teeth and is made of a plastic material and is injection-molded onto the outer rim of the connecting element, whereas the connecting element has a central through-going opening and the hub element is arranged in the through-going opening/BACKGROUND

A gearwheel of this type is known from the post-published document DE 10 2021 213 541 A1. Such a gearwheel can be in the form of a worm gear and be arranged in a worm gear system and/or a steering system of a vehicle.

In an assembled condition, for example in a steering system of a vehicle, the toothed rim can co-operate with a further gearwheel or with a worm shaft. In this assembled condition the hub element can accommodate an axle or a pinion. In that case the gearwheel must ensure reliable force and torque transmission. At the same time a lighter and/or more inexpensive structure is desirable.

### SUMMARY

The purpose of the present invention is to develop further a gearwheel of the type mentioned to begin with so as to make possible a lighter and/or more inexpensive structure. In particular an alternative embodiment should be provided.

The objective of the invention is achieved with a gearwheel as disclosed herein. Preferred further developments of the invention will be apparent from the Figures and the description that follows.

The gearwheel according to the invention has a three-part structure. This three-part structure consists of an outer toothed rim, a connecting element and an inner hub element. The outer toothed rim has a plurality of gearteeth. The teeth can be of any design, shape and orientation known from the prior art and appropriate for a gearwheel. The outer toothed rim is made from a plastic material and injection-molded onto the outer edge of the connecting element. In this context the outer toothed rim can be injection-molded onto and/or around the outer edge of the connecting element. In particular, the outer toothed rim can be injection-molded onto the outer edge of the connecting element by means of a diaphragm gate. The plastic material can be an unreinforced, or a fiber-reinforced plastic material. The plastic material can be friction-optimized and/or it can have self-lubricating properties. In particular, the outer toothed rim forms the outer circumference of the gearwheel.

The connecting element has a central through-going opening. In particular, the through-going opening extends in the axial direction of the central axis of the gearwheel. Preferably, the terms “outer” toothed rim and “inner” hub element refer to a radial alignment and/or positioning relative to the central axis of the gearwheel and/or relative to the connecting element and/or relative to the three structural elements in relation to one another.

The hub element is arranged in the through-going opening. In particular, the hub element is pressed into the through-going opening. Preferably, by virtue of the press-fit connection any relative displacement of the hub element in relation to the connecting element, particularly in the axial direction relative to the central axis of the gearwheel, is prevented or blocked. Alternatively, or in addition to the pressing-in of the hub element, the hub element can be connected to the connecting element by means of a bonding connection, in particular by means of an adhesion promoter and/or an adhesive material. The bonding connection can moreover be made by a welding method or a laser method.

According to the invention, the material thickness of the connecting element is less than that of the hub element, and the connecting element comprises a number of reinforcing structures.

In this respect it is advantageous that on the one hand, owing to the smaller material thickness of the connecting element compared with the hub element, a lighter and/or less expensive gearwheel can be produced. On the other hand, at the same time by virtue of the plurality of reinforcing structures, sufficient stability is ensured so that the gearwheel can reliably withstand forces and/or pass them on.

Preferably the gearwheel is in the form of a worm gear, in particular for the steering system of a vehicle. Such a worm gear can be combined with a worm shaft for driving the worm gear and a shaft or pinion shaft arranged in the hub element.

The through-going opening of the connecting element can have an internal contour which is round or out-of-round, in particular polygonal. In particular, the hub element is arranged inside the connecting element and/or in the middle of the connecting element. The hub element has an external contour that corresponds with the said internal contour, namely a round, out-of-round, in particular polygonal contour. In particular the said internal and external contours are arranged or formed coaxially or essentially coaxially with the central axis of the gearwheel. By virtue of an out-of-round internal contour of the through-going opening and an out-of-round external contour of the hub element, at the same time any relative displacement of the hub element in relation to the connecting element and in the circumferential direction of the external contour is blocked. On its outer circumference the hub element can be knurled. The knurling can impede or block any relative movement of the hub element relative to the connecting element. Preferably, interlocking elements, in particular undercuts and/or projections of the hub element and the connecting element that correspond with one another, secure the hub element on the connecting element. Such interlocking elements can be, or are produced by, deformation techniques. According to a further alternative, the surfaces of the external contour of the hub element and the inside of the through-going opening of the connecting element can be made smooth. In that case the connection between the hub element and the connecting element is, or can be, a bonding connection. The bonding connection can be, or can be, produced by means of an adhesion-promoter or an adhesive or by welding, especially laser welding.

According to a further embodiment the hub element has a central, hollow-cylindrical aperture. In particular, the hollow-cylindrical aperture serves for the arrangement or pressing of the gearwheel onto a shaft which has a cylindrical section or a cylindrical outer surface. Preferably, the shaft is in the form of a pinion shaft. The combination of a gearwheel according to the invention with a pinion shaft can be used, for example, in a steering system of a vehicle.

Preferably, the hub element is made of metal, in particular a cold-extruded component or a section of a bar or a tube. The connecting element can be made of metal or sheet-metal. To form the connecting element the metal sheet can be deformed. In particular, the hub element is made from a first metal and the connecting element from a second metal different from the first metal. The outer toothed rim is made of a plastic material. This, the gearwheel can be a hybrid gearwheel made of different materials.

According to a further development, the reinforcing structures are produced by reshaping the material of the connecting element. In particular, the reinforcing structures are integral parts of the connecting element. The connecting element can be produced as a reshaped sheet component. During the production of the connecting element by reshaping the metal sheet, at the same time the reinforcing structures can be produced by predetermined local deformation of the metal sheet. The reinforcing structures can be in the form of grooves, ribs, and/or beading. Such reinforcing structures can be produced simply and inexpensively by stamping the metal sheet used to form the connecting element.

According to a further embodiment, the connecting element is formed of a first wall section, a second wall section and an annular section. In this configuration the annular section connects the first wall section to the second wall section. In particular, the first wall section, the second wall section and the annular section are formed by shaping a metal sheet to produce the connecting element. The reinforcing structures can be produced in the first wall section and/or the annular section.

Preferably, the first wall section forms the outer wall of the connecting element. Thus, the plastic material for forming the outer toothed rim is injection-molded onto the first wall section. In particular, at least the first wall section is completely embedded in the plastic material of the outer toothed rim. The plastic material can extend into an intermediate space between the first wall section and the second wall section. The said intermediate space can be partially or completely filled with the plastic material of the outer toothed rim. A side of the second wall section that faces away from the hub element can be covered by the plastic material of the outer toothed rim. Preferably, however, only the first wall section is embedded in the plastic material of the outer toothed rim and the second wall section, or a side of the second wall section facing away from the hub element, is left free. Thus, the second wall section can remain uncovered by the plastic material of the outer toothed rim.

The second wall section can form the through-going opening for receiving the hub element. The plastic material of the outer toothed rim can extend along one side of the connecting element, in particular a side of the annular section, as far as the hub element. The plastic material can cover an end side of the hub element. In that way there is an additional interlock between the plastic material of the outer toothed rim and the end of the hub element. In particular this interlock acts in the axial direction of the central axis of the gearwheel.

In particular, the first wall section and/or the second wall section extend(s) in the axial direction and/or parallel to the central axis of the gearwheel. Preferably, the annular section extends between the two wall sections, radially relative to the central axis of the gearwheel. The two wall sections can thus be orientated transversely or perpendicularly to the annular section. In particular, the two wall sections extend in the same direction away from the annular section. The first wall section and/or the second wall section can essentially be of annular and/or polygonal shape. Furthermore, the first wall section and/or the second wall section can be arranged or formed coaxially with the central axis of the gearwheel. Preferably, the first wall section, the second wall section and the annular section form a channel which is round and/or U-shaped.

According to a further development, a reinforcing structure in the form of a groove is formed in the first wall section. In this case the reinforcing structure in the form of a groove extends in the axial direction and/or parallel to the central axis of the gearwheel. In particular, the reinforcing structure in the form of a groove extends projection-like and/or radially outward. The groove can have a curved, circular segment, or semicircular cross-section. In particular, such a cross-section has its open side in the direction toward the central axis of the gearwheel. Corresponding reinforcing structures or grooves can be made simply and inexpensively by deforming a metal sheet to produce the connecting element. In each case a section between two directly adjacent grooves can be plate shaped. In particular, the said section has a flat inner side and a flat outer side arranged radially relative to the central axis. The first wall section can have a plurality of these plate-shaped sections. Preferably, by virtue of the plurality of plate-shaped sections the first wall section has a polygonal or polygon-like basic shape. In particular, each reinforcing structure, preferably the reinforcing structure in the form of a groove, forms a transition between two adjacent plate-shaped sections.

In particular, by virtue of the reinforcing structures the load and/or torque transfer between the toothed rim and the connecting element is improved. In this, when subjected to a torsional load, in particular due to a shaft or worm shaft that co-operates with the toothed rim, the plastic material of the toothed rim can be supported by the reinforcing structure.

Preferably, the reinforcing structures in the form of grooves in the first wall section each have an open end and a closed end. In particular, the closed end is formed due to a transition of the first wall section into the annular section. Thus, the open end of the groove can be arranged or formed at an edge of the first wall section remote from the annular section.

Preferably, the reinforcing structures in the form of grooves in the first wall section each have a radially convex contour on an external side of the first wall section and a radially concave contour on an internal side of the first wall section. In particular, the radially convex and radially concave contours face in the radial direction toward the central axis of the gearwheel. Preferably, the outside of the first wall section faces away from the second wall section. The inside of the first wall section can face toward the second wall section. In particular, the plurality of reinforcing structures in the first wall section is formed on the first wall section, distributed uniformly, and evenly spaced apart in the circumferential direction around the central axis of the gearwheel. Preferably, by means of the reinforcing structures in the first wall section, a connection, in particular an interlock between the connecting element and the plastic material of the outer toothed rim, is improved.

According to a further development, between the reinforcing structures formed as grooves in the first wall section, in each case a material aperture is formed. In particular, in each case one or more than one material aperture(s) is/are formed between reinforcing structures in the form of grooves directly adjacent to one another. Alternatively, one or more material aperture(s) can be formed only between specified pairs of directly adjacent reinforcing structures in the form of grooves. For example, at least one material aperture is formed between every second or every third pair of directly adjacent reinforcing structures in the form of grooves, whereas between the respective other pairs of directly adjacent reinforcing structures in the form of grooves, no material aperture is formed.

Alternatively, or in addition, a groove surface of each groove can have a material aperture. In particular the groove surface is in the form of a groove base of the groove. In particular, the groove surface and/or the groove base forms a radially outward-directed projection of the connecting element.

A material aperture can be produced by stamping or drilling. The material aperture can for example be in the form of a hole or an elongated hole or a slot. In particular, the material aperture is filled with the plastic material of the outer toothed rim. In that way the connection, and in particular an interlock between the outer toothed rim and the connecting element is further improved. Preferably, by virtue of the material aperture, a load transfer and/or torque transfer between the toothed rim and the connecting element is improved.

In a further embodiment, in the annular section a reinforcing structure, in each case in the form of a rib, is produced. Such ribs can be produced simply and inexpensively by deforming a metal sheet in order to produce the connecting element. The ribs extend in each case in the radial direction relative to the central axis of the gearwheel. In particular, the reinforcing structures in the form of ribs extend in the annular section starting from the second wall section and ending in a central area of the annular section. Alternatively, the ribs can extend as far as the first wall section. By means of the reinforcing structures in the form of ribs in the annular section, the rigidity of the connecting element can be improved.

Preferably, the reinforcing structures in the form of ribs in the annular section have an axially convex contour on a first side of the annular section and an axially concave contour on a second side of the annular section that faces away from the first side. In particular, the axially convex and axially concave contours face in the direction toward the central axis of the gearwheel. The plurality of reinforcing structures in the annular section can be distributed uniformly and a distance apart from one another around the central axis of the gearwheel.

Between the connecting element, in particular the first wall section thereof, and the plastic material of the outer toothed rim, an adhesion promoter can be provided. An appropriate adhesion promoter can, for example, be applied to the outside and/or to the inside of the first wall section before the overmolding of the outer edge of the connecting element. By means of the adhesion promoter, a bond between the plastic material of the outer toothed rim and the metal of the connecting element can be produced or improved.

### BRIEF DESCRIPTION OF THE DRAWINGS

Below, the invention is explained in greater detail with reference to the figures. In these, the same indexes denote the same, similar, or functionally equivalent components or elements. The figures show:

FIG. 1: A perspective side view of a first gearwheel according to the invention,

FIG. 2: A perspective, partially sectioned side view of a second gearwheel according to the invention,

FIG. 3: A partially sectioned side view of the further gearwheel according to the invention shown in FIG. 2,

FIG. 4: Part of a sectioned side view of the further gearwheel according to the invention shown in FIGS. 2 and 3,

FIG. 5: A perspective and partially sectioned side view of a third gearwheel according to the invention,

FIG. 6: A perspective side view of a further connecting element for producing a further gearwheel according to the invention.

### DETAILED DESCRIPTION

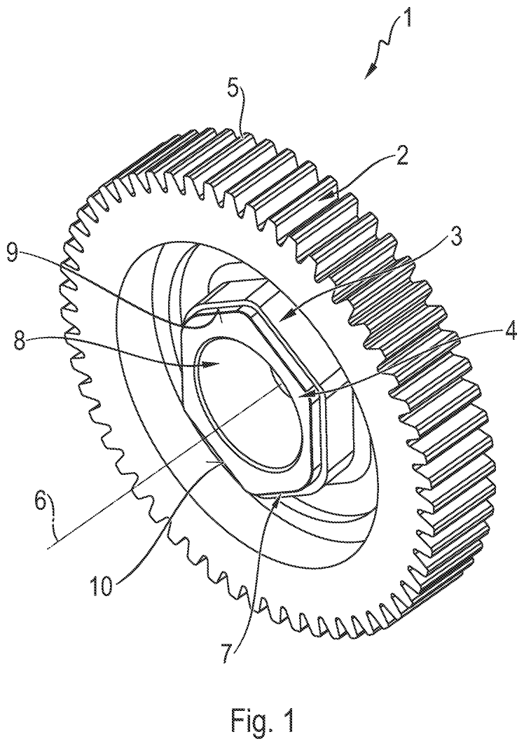

FIG. 1 shows a perspective side view of a first gearwheel 1 according to the invention. In this example embodiment, the gearwheel 1 is in the form of a worm gear for a steering system of a vehicle. Moreover, in this example embodiment the gearwheel 1 consists of three parts. The gearwheel 1 is formed of an outer toothed rim 2, a connecting element 3, and a hub element 4.

On its outer circumference the outer toothed rim 2 has a plurality of teeth 5. For greater clarity, not all the teeth 5 are indexed. In this example embodiment the teeth 5 extend radially outward relative to a central axis 6 of the gearwheel 1. Furthermore, in this example embodiment the teeth 5 are orientated parallel to the axial direction of the central axis 6. Alternatively, the teeth 5 can, for example, be orientated obliquely to the central axis 6, whereby a helical gear can be made. The outer toothed rim is made of a plastic material. In this case the outer toothed rim is injection-molded onto an outer edge (not visible) of the connecting element 3.

The connecting element 3 has a central through-going opening 7. In this through-going opening 7 is arranged the hub element 4. In this example embodiment the hub element 4 is press-fitted into the through-going opening. Thus, the connecting element 3 connects the outer toothed rim to the hub element 4.

The hub element 4 has a central hollow-cylindrical aperture 8. The aperture 8 serves for the arrangement or pressing of the gearwheel 1 onto a shaft (not shown) with a cylindrical section or a cylindrical outer surface. A corresponding shaft can for example be in the form of a pinion shaft.

In this example embodiment the through-going opening 7 has a polygonal contour, namely, a hexagonal internal contour 9. The hub element 4 is arranged in the internal contour 9. For that purpose, the hub element 4 has an external contour 10 which is correspondingly of polygonal, namely, hexagonal shape. In this example embodiment the corners of the internal contour 9 and the external contour 10 are rounded. By virtue of the co-operation of the internal contour 9 and the external contour 10, any relative displacement of the hub element 4 relatively to the connecting element 3 in the circumferential direction of the external contour 10 is blocked. At the same time, owing to the press-fitted connection between the hub element 4 and the connecting element 3, any relative displacement of the hub element 4 relatively to the connection element 3 in the axial direction of the central axis 6 of the gearwheel 1 is prevented.

In this example embodiment, both the connecting element 3 and also the hub element 4 are made of metal. For example, the hub element 4 is in the form of a cold-extruded component. The connecting element 3 is made from a deformed metal sheet.

The thickness of the connecting element 3 is less than that of the hub element 4. Furthermore, the connecting element 3 has reinforcing structures (not shown here), which are arranged in the area of the outer edge of the connecting element 3 and are enclosed by the plastic material of the outer toothed rim 2. The form of the reinforcing structures in the area of the outer edge of the connecting element 3 will be explained with reference to the figures that follow.

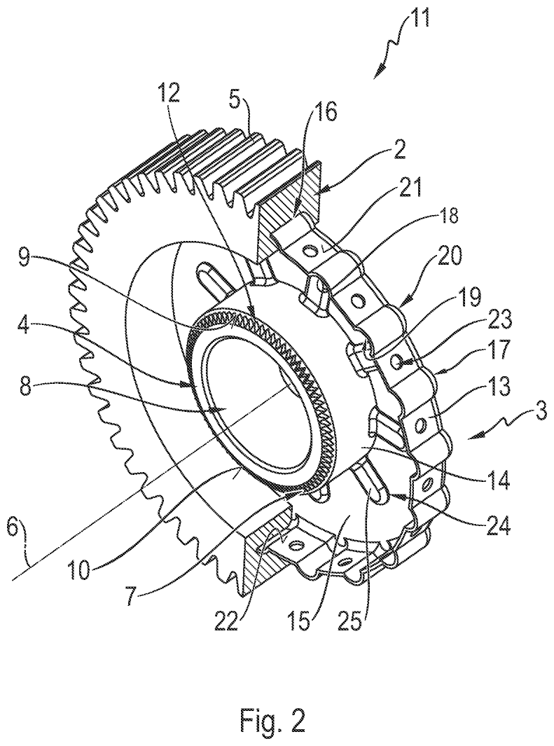

FIG. 2 shows a perspective and partially sectioned side view of a further gearwheel 11 according to the invention. The basic structure of the gearwheel 11 corresponds essentially to that of the gearwheel 1 shown in FIG. 1. The same features are given the same indexes as before. Accordingly, to avoid repetitions reference can also be made to the previous description.

In contrast to the gearwheel 1 of FIG. 1, the through-going opening 7 has a circular internal contour 9 in this example embodiment. To fit the hub element 4 in the circular internal contour 9, the hub element 4 has a circular external contour 10 that corresponds to the internal contour 9. In addition, the hub element 4 has knurling 12 on its outer periphery in this example embodiment. When the hub element 4 is pressed into the through-going opening 7 of the connecting element 3, the knurling 12 cuts into the internal contour 9. In that way a relative displacement of the hub element 4 relatively to the connecting element 3 in the circumferential direction of the external contour 10 is additionally blocked.

The connecting element 3 has a first wall section 13 and a second wall section 14. In addition, the connecting element 3 has an annular section 15 which connects the first wall section 13 and the second wall section 14 to one another. In other words, in this example embodiment the connecting element 3 is formed by the first wall section 13, the second wall section 14, and the annular section 15. In this case the two wall sections 13, 14 extend, respectively, in the axial direction or parallel to the central axis 6 of the gearwheel 11. The annular section 15 extends radially relative to the central axis 6 of the gearwheel 11 and between the two wall sections 13, 14. Starting from the annular section 15, the two wall sections 13 and 14 extend axially relative to the central axis 6 away from the annular section 15 in the same direction.

The first wall section 13 at the same time forms an outer edge 16 of the connecting element 3. In this example embodiment the first wall section 13 or the said outer edge 16 is ring-shaped or polygon-shaped. The outer toothed rim 2 is injection-molded onto the outer edge 16 of the connecting element 3. In this example embodiment the first wall section 13 is completely embedded in the plastic material of the outer toothed rim 2.

The second wall section 14 at the same time forms the internal contour 9 of the connecting element 3 for the interlocking accommodation of the external contour 10 of the hub element 4.

The first wall section 13 has a plurality of reinforcing structures 17. The reinforcing structures 17 are in this case each in the form of a groove 18. For the sake of better clarity, not all the reinforcing structures 17 and grooves 18 are indexed. The grooves 18 each extend in the axial direction and parallel to the central axis 6 of the gearwheel 11. The grooves 18 have a curved, in this case semicircular cross-section. The grooves 18 have an open end 19 and a closed end 20. In this case the closed end 20 is formed due to a transition of the first wall section 13 into the annular section 15.

The reinforcing structures 17 are formed by deformation of the material of the metal sheet that forms the connecting element 3. The grooves 18 each form on the outside 21 of the first wall section 13 a convex contour extending radially relative to the central axis 6, and on the inside 22 of the first wall section 13 form a concave contour relative to the central axis 6. The plurality of reinforcing structures 17 or grooves 18 are distributed uniformly on the first wall section 13 around the central axis 6 of the gearwheel 11 and a distance apart from one another.

In this example embodiment, between the reinforcing structures 17 in the form of grooves 18 there is in each case a material aperture 23 in the first wall section 13. The material aperture 23 is formed, for example, by stamping out or drilling. In this case, for example, the material apertures 23 are in the form of round holes. During the overmolding of the outer edge 16 of the connecting element 3, to form the connecting element 3 the plastic material penetrates into the material apertures 23. By means of the reinforcing structures 17 and the material apertures 23, the interlock between the outer toothed rim 2 and the connecting element 3 is improved. The reinforcing structures 17 also improve the rigidity of the first wall 13.

The connecting element 3 of the gearwheel 1 in FIG. 1 has a first wall section 13 as shown in the example embodiment of FIG. 2.

In this example embodiment the connecting element 3 of the gearwheel 11 in FIG. 2 has further reinforcing structures 24 in the annular section 15. These further reinforcing structures 24 in the annular section 15 are in each case in the form of a rib 25. For greater clarity, not all of the said reinforcing structures 24 or ribs 25 are indexed.

The further reinforcing structures 24 or ribs 25 are produced by deforming the material during the production of the connecting element 3. In this example embodiment, the ribs 25 extend in the annular section 15, starting from the second wall section 14 and ending in a central area of the annular section 15.

By means of the further reinforcing structures 24 or ribs 25 the rigidity of the annular section 15 or connecting element 3 is improved.

In an alternative embodiment, the gearwheel 1 or connecting element 3 of the gearwheel 1 in FIG. 1 can also have further reinforcing structures 24 or ribs 25, such as in the gearwheel 11 shown in FIG. 2.

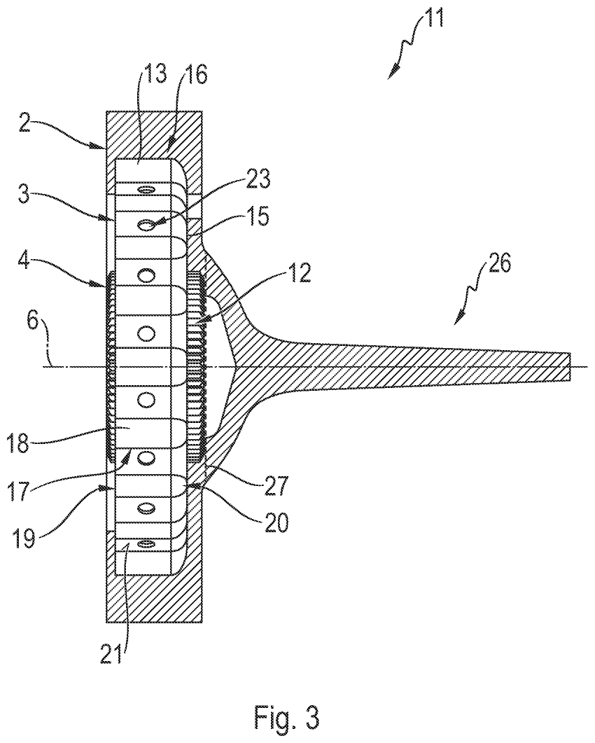

FIG. 3 shows a partially sectioned side view of the further gearwheel 11 shown in FIG. 2. In this case, the gearwheel 11 is shown immediately after the overmolding of the connecting element 3 with the plastic material for the production of the outer toothed rim 2. In this example embodiment, the overmolding takes place by means of a diaphragm gate 26. For the final production of the gearwheel 11 of FIG. 2, the diaphragm gate 26 is separated or cut away along a schematically indicated separation line 27.

Furthermore, it can be seen clearly in this case that as viewed in the axial direction of the central axis 6, the connecting element 3 has a narrower width than the hub element 4. The width of the outer toothed rim 2 is essentially the same as the width of the hub element 4.

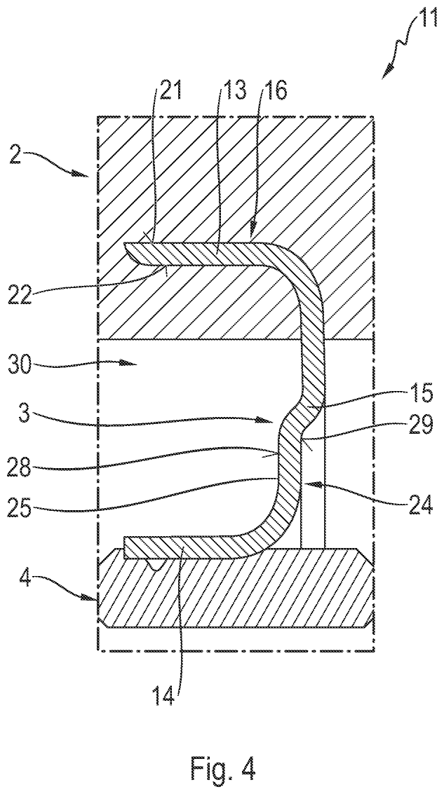

FIG. 4 shows part of a sectioned side view of the further gearwheel 11 shown in FIGS. 2 and 3. The further reinforcing structures 24 in the form of ribs 25 in the annular section 15 each have on a first side 28 of the annular section 15 a convex contour extending axially relative to the central axis 6 of the gearwheel 11, and on a second side 29 of the annular section 15 facing away from the first side 28 have a concave contour axially relative to the central axis of the gearwheel 11.

The two wall sections 13, 14 and the annular section 15 form a ring-like channel with an intermediate space 30. In this example embodiment, to embed the first wall section 13 the plastic material of the outer toothed rim 2 extends partially into the said intermediate space 30. In this example embodiment, the second wall section 14 is not covered by the plastic material of the outer toothed rim 2. Thus, in this case, the side of the wall section 14 facing away from the hub element 4 and an area of the annular section 15 close to it are free.

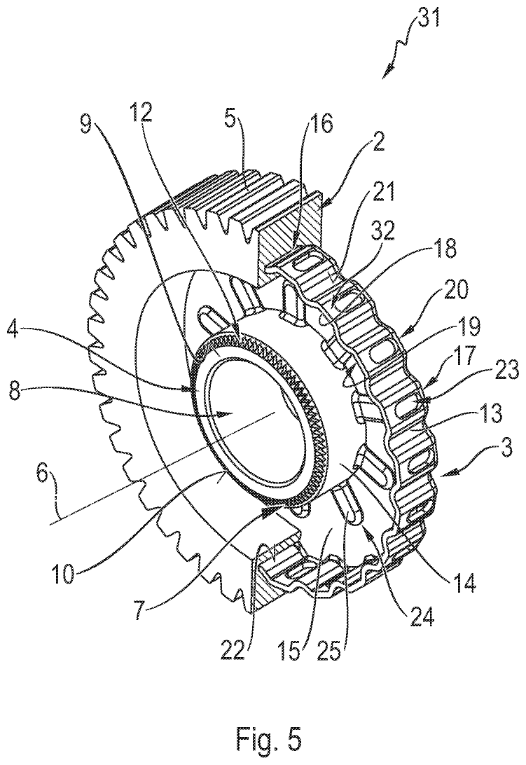

FIG. 5 shows a perspective and partially sectioned side view of a third gearwheel 31 according to the invention. The same features are given the same indexes as before. Accordingly, to avoid repetitions reference can be made to the previous description.

In contrast to the gearwheels 1, 11 shown in FIGS. 1 to 4, in the gearwheel 31 shown here the material apertures 23 are not formed between the grooves 18 but in the groove surfaces 32 of the respective grooves 18. In this case each groove surface 32 forms a groove base of the groove 18. The groove surface 32 also forms a projection extending outward relative to the central axis 6. In this example embodiment the material apertures 23 are in the shape of slots.

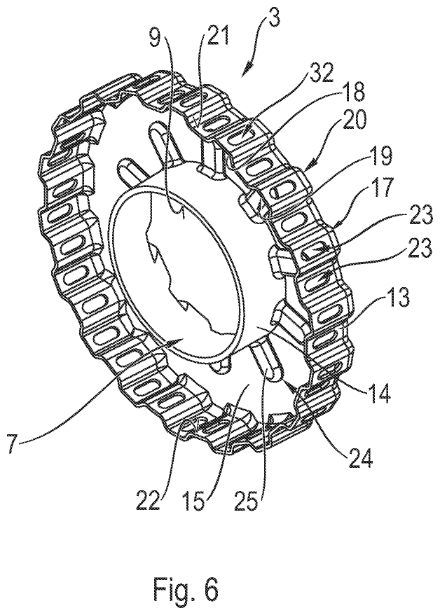

FIG. 6 shows a perspective side view of a further connection element 3 for forming a further gearwheel (no more of which is shown here). In this representation the toothed rim 2 and the hub element 4 are omitted. The same features are given the same indexes as before. Accordingly, to avoid repetitions reference can be made to the previous description.

The connecting element 3 shown here corresponds essentially to the connecting element 3 shown in FIG. 5. In addition to the material apertures 23 in the groove surfaces 32 of each groove 18, in this example embodiment, in accordance with the gearwheels 1, 11 shown in FIGS. 1 to 4, there is in each case a further material aperture 23 between two directly adjacent grooves 18. In this case, for example, all the material apertures 23 are in the form of slots. Alternatively, the material apertures 23 can be round holes or slits open on one side.
1 Gearwheel
2 Toothed rim
3 Connecting element
4 Hub element
5 Tooth
6 Central axis
7 Through-going opening
8 Aperture
9 Internal contour
10 External contour
11 Gearwheel
12 Knurling
13 First wall section
14 Second wall section
15 Annular section
16 Outer edge
17 Reinforcing structure
18 Groove
19 Open end
Closed end
21 Outside
22 Inside
23 Material aperture
24 Reinforcing structure
25 Rib
26 Diaphragm gate
27 Separation line
28 First side
29 Second side
30 Intermediate space
31 Gearwheel
32 Groove surface

1. A gearwheel with a three-part structure consisting of:
an outer toothed rim (2);
a connecting element 3; and
a hub element (4), wherein the outer toothed rim (2) has a plurality of teeth (5) and is made of a plastic material injection-molded onto an outer rim (16) of the connecting element (3), wherein the connecting element (3) has a central through-going opening (7) and the hub element (4) is arranged in the said through-going opening (7), and wherein a material thickness of the connecting element (3) is less than a material thickness of the hub element (4) and the connecting element (3) has a plurality of reinforcing structures (17, 24).

2. The gearwheel according to claim 1, wherein the reinforcing structures (17, 24) are produced by deforming the material of the connecting element (3), and the reinforcing structures (17, 24) are integral parts of the connecting element (3).

3. The gearwheel according to claim 1, wherein the connecting element (3) is formed of a first wall section (13), a second wall section (14) and an annular section (15), wherein the annular section (15) connects the first wall section (13) to the second wall section (14), and the reinforcing structures (17, 24) are formed on the first wall section (13) and/or on the annular section (15).

4. The gearwheel according to claim 3, wherein the first wall section (13) forms an outer edge (16) of the connecting element (3) and the second wall section (14) forms the through-going opening (7) for receiving the hub element (4), wherein the first wall section (13) and/or the second wall section (14) extend(s) in an axial direction and/or parallel to a central axis (6) of the gearwheel (1, 11), and wherein the annular section (15) extends radially relative to the central axis (6) of the gearwheel (1, 11).

5. The gearwheel according to either of claim 3 or 4, claim 3, wherein the first wall section (13) has a respective reinforcing structure (17) in the form of a groove (18), wherein the groove (18) extends in an axial direction and/or parallel to a central axis (6) of the gearwheel (1, 11, 31), and in particular wherein the groove (18) has a curved, circular-segment or semicircular cross-section, and preferably wherein the reinforcing structure (17) in the form of a groove (18) extends outward like a projection and/or radially relative to a central axis (6) of the gearwheel (1, 11, 31).

6. The gearwheel according to claim 5, wherein each respective reinforcing structure (17) in the first wall section (13) defines an open end (19) and a closed end (20), the closed end (20) being formed by virtue of a transition of the first wall section (13) into the annular section (15).

7. The gearwheel according to claim 5, wherein each respective reinforcing structure (17) in the first wall section (13) has a radially convex contour on an outside (21) of the first wall section (13) and a radially concave contour on an inside (22) of the first wall section (13), the reinforcing structures (17) in the first wall section (13) being distributed uniformly in a circumferential direction around a central axis (6) of the gearwheel (1, 11, 31) and a distance apart from one another on the first wall section (13).

8. The gearwheel according to claim 5, wherein a material aperture (23) is defined between adjacent reinforcing structures (17) in the first wall section (13), and/or a material aperture is defined in a groove surface (32) of the groove (18) material aperture (23) being filled with the plastic material of the outer toothed rim (2).

9. The gearwheel according to claim 3, wherein the annular section (15) has a reinforcing structure (24) in the form of a rib (25), the said rib (25) extending in a radial direction relative to a central axis (6) of the gearwheel (11, 31), and the reinforcing structure (24) starting from the second wall section (14) and ending is a central area of the annular section (15).

10. The gearwheel according to claim 9, wherein each reinforcing structure in the form of the rib (25) in the annular section (15) has an axially convex contour on a first side (28) of the annular section (15) and has an axially concave contour on a second side (29) of the annular section (15) facing away from the first side (28), and the reinforcing structures (24) in the annular section (15) are distributed uniformly in the circumferential direction around a central axis (6) of the gearwheel (11, 31) and a distance apart from one another on the annular section (15).
